(19) United States
(12) Patent Application Publication
(10) Pub. No.: US 2026/0064066 A1
(43) Pub. Date: Mar. 5, 2026

(54) TRANSPORT DEVICE AND IMAGE FORMING APPARATUS

(71) Applicant: FUJIFILM Business Innovation Corp., Tokyo (JP)

(72) Inventor: Koji DEGUCHI, Kanagawa (JP)

(73) Assignee: FUJIFILM Business Innovation Corp., Tokyo (JP)

(21) Appl. No.: 19/037,057

(22) Filed: Jan. 24, 2025

(30) Foreign Application Priority Data
Aug. 27, 2024 (JP) 2024-145962

(51) Int. Cl. G03G 15/00

(52) U.S. Cl. CPC G03G 15/6561; G03G 15/6567; G03G 15/6594; G03G 2215/00481

(57) ABSTRACT

A transport device includes: a pair of registration rollers that transport a recording medium to a transfer part at a predetermined timing; a pair of transport rollers that are provided upstream of the pair of registration rollers in a recording-medium transport direction and transport the recording medium toward the pair of registration rollers that are not rotated; a first guide part that is provided downstream of the pair of transport rollers in the recording-medium transport direction and guides the recording medium to the pair of registration rollers; a second guide part that is provided downstream of the pair of registration rollers in the recording-medium transport direction and guides the recording medium to the transfer part; a position changing mechanism that changes positions of the first guide part and the second guide part according to a type of the recording medium; and a pressure changing mechanism that changes a contact pressure between the pair of transport rollers in conjunction with the first guide part that has been moved by the position changing mechanism.

### CROSS-REFERENCE TO RELATED APPLICATIONS

This application is based on and claims priority under 35 USC 119 from Japanese Patent Application No. 2024-145962 filed Aug. 27, 2024.

### BACKGROUND

### (i) Technical Field

The present disclosure relates to a transport device and an image forming apparatus.

### (ii) Related Art

For example, Japanese Unexamined Patent Application Publication No. 2012-062194 discloses an image forming apparatus including: an image forming section that forms an image on a recording medium; and a skew correction unit that corrects skew by causing the recording medium to abut against a gate on a transport path through which the recording medium is transported toward the image forming section. The skew correction unit includes, above and below the transport path, a transport guide and a movable guide for guiding the recording medium. The movable guide moves in the thickness direction of the recording medium, independently of the transport unit and the transport guide, to guide the recording medium.

Furthermore, Japanese Unexamined Patent Application Publication 2012-098543 discloses an image forming apparatus including an image processing device that transfers a toner image formed on an image carrier to various types of recording materials. The image forming apparatus includes: a registration roller that transports a recording material toward a transfer position of the image processing device at a predetermined timing; movable guide bodies constituting a curved pre-transfer path extending from the registration roller to the transfer position; and an orientation changing unit that changes the orientation of the movable guide bodies to change the path of the curved pre-transfer path.

Furthermore, Japanese Unexamined Patent Application Publication No. 2006-323154 discloses an image forming apparatus in which a guide member including second transfer feed guides for guiding a sheet material is provided in a section between registration rollers disposed on the upstream side of a transport path of the sheet material, serving as recording paper, and second transfer rollers disposed on the downstream side of the transport path. One of the second transfer feed guides has a sheet correcting plate (movable part) for adjusting the front and rear of a sheet by moving an abutting portion such that the leading end of the sheet material is parallel to the sheet width direction orthogonal to the transport direction, and a part of the plate serves as a correcting part against which the sheet material being transported is abutted.

### SUMMARY

Aspects of non-limiting embodiments of the present disclosure relate to providing a transport device with which a transport error of a recording medium to a transfer part is suppressed, compared with the case where the contact pressure, with respect to a recording medium, of a pair of transport rollers provided upstream of a pair of registration rollers in a recording-medium transport direction and the width of a transport path on the downstream side of the pair of registration rollers in the recording-medium transport direction are constant regardless of the type of the recording medium.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a transport device including: a pair of registration rollers that transport a recording medium to a transfer part at a predetermined timing; a pair of transport rollers that are provided upstream of the pair of registration rollers in a recording-medium transport direction and transport the recording medium toward the pair of registration rollers that are not rotated; a first guide part that is provided downstream of the pair of transport rollers in the recording-medium transport direction and guides the recording medium to the pair of registration rollers; a second guide part that is provided downstream of the pair of registration rollers in the recording-medium transport direction and guides the recording medium to the transfer part; a position changing mechanism that changes positions of the first guide part and the second guide part according to a type of the recording medium; and a pressure changing mechanism that changes a contact pressure between the pair of transport rollers in conjunction with the first guide part that has been moved by the position changing mechanism.

### BRIEF DESCRIPTION OF THE DRAWINGS

Exemplary embodiments of the present disclosure will be described in detail based on the following figures, wherein:

FIG. 1 is a schematic side view showing the overall configuration of an image forming apparatus according to a first exemplary embodiment;

FIG. 2 is a schematic perspective view showing a guide part and a pressure changing mechanism of a transport device according to the first exemplary embodiment;

FIG. 3 is an enlarged schematic side view showing a state of a position changing mechanism when thick paper is transported by the transport device according to the first exemplary embodiment;

FIG. 4 is an enlarged schematic side view showing a state of the position changing mechanism when normal paper is transported by the transport device according to the first exemplary embodiment;

FIG. 5 is an enlarged schematic side view showing a state of the position changing mechanism when thick paper is transported by the transport device according to a second exemplary embodiment; and

FIG. 6 is an enlarged schematic side view showing a state of the position changing mechanism when normal paper is transported by the transport device according to the second exemplary embodiment.

### DETAILED DESCRIPTION

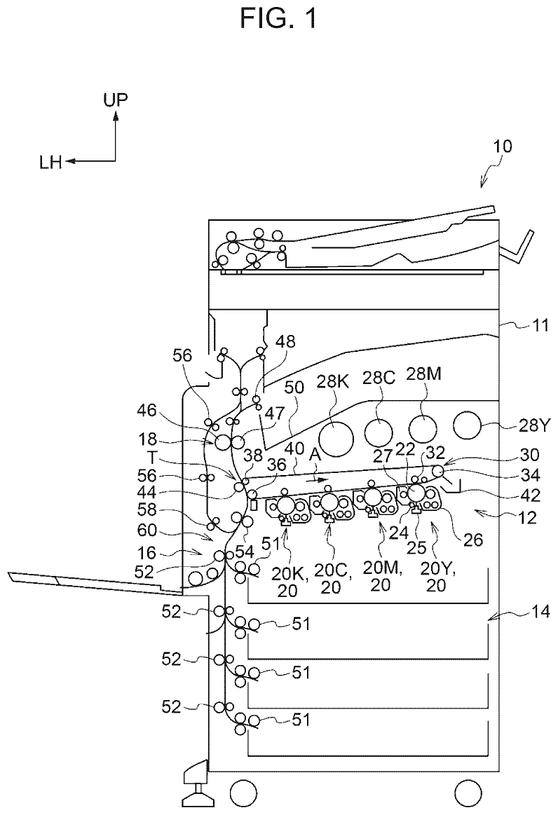

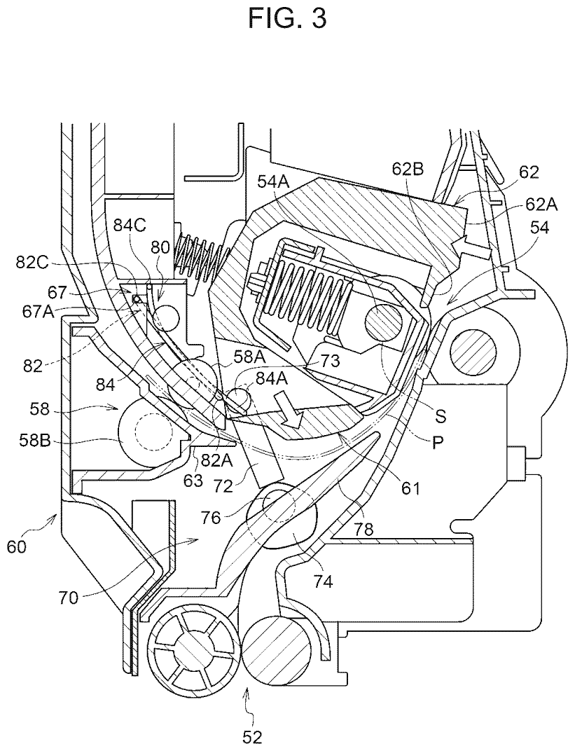

Hereinbelow, exemplary embodiments of the present disclosure will be described in detail with reference to the drawings. For convenience of description, in FIG. 1, arrow UP indicates the upward direction of the image forming apparatus 10, arrow LH indicates the leftward direction of the image forming apparatus 10, and the direction toward the viewer is the forward direction of the image forming apparatus 10. In the following description, the upstream side in the transport direction of recording paper P, serving as an example of a recording medium (see FIGS. 3 to 6), may be simply referred to as the “upstream side”, and the downstream side in the transport direction may be simply referred to as the “downstream side”.

### First Exemplary Embodiment

A first exemplary embodiment will be described. As shown in FIG. 1, the image forming apparatus 10 is, for example, an electrophotographic image forming apparatus that forms a toner image on recording paper P. The image forming apparatus 10 includes, in an apparatus body 11, an image forming section 12, storage parts 14, a transport section 16 (including a transport device 60), and a fixing device 18. The image forming section 12, the transport section 16, and the fixing device 18 of the image forming apparatus 10 will be described.

### Image Forming Section

The image forming section 12 forms a toner image on recording paper P. Specifically, the image forming section 12 includes toner image forming units 20 and an intermediate transfer device 30. In this exemplary embodiment, examples of the recording paper P include thick paper and normal paper, which is thinner than thick paper. The thick paper in this exemplary embodiment is paper having a grammage of, for example, 300 g/m² or more.

### Toner Image Forming Unit

As shown in FIG. 1, there are multiple toner image forming units 20 for forming toner images of respective colors. In this exemplary embodiment, toner image forming units 20Y, 20M, 20C, and 20K corresponding to a total of four colors, i.e., yellow (Y), magenta (M), cyan (C), and black (K), are provided.

Because the toner image forming units 20 corresponding to the respective colors have the same structure, in FIG. 1, only the respective parts of the yellow toner image forming unit 20Y are denoted by reference signs. The apparatus body 11 also accommodates toner supply devices 28Y, 28M, 28C, and 28K that supply toner to developing devices 26 (described below).

The toner image forming units 20 corresponding to the respective colors each include a photoconductor drum 22 that rotates in one direction (for example, a counterclockwise direction in FIG. 1) about an axis extending in a front-rear direction. The toner image forming unit 20 also includes a charger 24, an exposure device 25, a developing device 26, and a removal device 27 in this order from the upstream side in the rotation direction of the photoconductor drum 22.

In the toner image forming unit 20, the charger 24 charges the outer circumferential surface of the photoconductor drum 22. Then, the exposure device 25 irradiates the outer circumferential surface of the photoconductor drum 22, charged by the charger 24, with light to form an electrostatic latent image on the outer circumferential surface of the photoconductor drum 22. The developing device 26 develops the electrostatic latent image, formed on the outer circumferential surface of the photoconductor drum 22 by the exposure device 25, to form a toner image. Then, the removal device 27 removes the toner remaining on the outer circumferential surface of the photoconductor drum 22 after the toner image is transferred to a transfer belt 40 described below.

### Intermediate Transfer Device

As shown in FIG. 1, the intermediate transfer device 30 includes a first transfer roller 32, serving as an example of a first transfer body, having an axis extending in the front-rear direction, the transfer belt 40, serving as an example of an intermediate transfer body, and a second transfer roller 44, serving as an example of a second transfer body, having an axis extending in the front-rear direction. In the intermediate transfer device 30, the toner images formed on the outer circumferential surfaces of the photoconductor drums 22 corresponding to the respective colors are first-transferred to the transfer belt 40 in a superimposed manner, and the superimposed toner images are second-transferred to the recording paper P.

### First Transfer Roller

As shown in FIG. 1, the first transfer rollers 32 transfer the toner images formed on the outer circumferential surfaces of the photoconductor drums 22 to the outer peripheral surface of the transfer belt 40 in a superimposed manner at first transfer positions between the photoconductor drums 22 and the first transfer rollers 32. In this exemplary embodiment, by applying a first transfer voltage between the first transfer rollers 32 and the photoconductor drums 22, the toner images formed on the outer circumferential surface of the photoconductor drums 22 are transferred to the outer peripheral surface of the transfer belt 40 in a superimposed manner at the first transfer positions.

### Transfer Belt

As shown in FIG. 1, the transfer belt 40 is an endless belt to the outer peripheral surface of which the toner images are transferred, and is wound around and is held in place by a driving roller 34, a tension roller 36, and a backup roller 38 having axes extending in the front-rear direction. The driving roller 34 is rotationally driven by a driving unit (not shown) to cause the transfer belt 40 to circulate in arrow A direction (clockwise direction in FIG. 1) at a predetermined speed. A cleaning device 42 that cleans the outer peripheral surface of the transfer belt 40 is provided on the opposite side of the transfer belt 40 from the driving roller 34.

The backup roller 38 is opposed to the second transfer roller 44 with the transfer belt 40 therebetween. The contact region where the second transfer roller 44 and the transfer belt 40 are in contact with each other, or the region where recording paper P is nipped between the second transfer roller 44 and the transfer belt 40, serves as a nip region. The nip region serves as a second transfer position T, which is an example of a transfer part, where the toner image is transferred from the transfer belt 40 to the recording paper P.

### Fixing Device

As shown in FIG. 1, the fixing device 18 includes a heating roller 46, serving as an example of a heating member, having an axis extending in the front-rear direction, and a pressure roller 47, serving as an example of a pressure member, having an axis extending in the front-rear direction. The fixing device 18 applies heat and pressure to the recording paper P while sandwiching the recording paper P between the heating roller 46 and the pressure roller 47 rotating in opposite directions to fix the toner image transferred to the recording paper P by the second transfer roller 44. A discharge roller 48 having an axis extending in the front-rear direction is provided downstream of the fixing device 18 to discharge the recording paper P, having the toner image fixed thereto, to a discharging part 50 provided in the upper part of the apparatus body 11.

### Transport Section

As shown in FIG. 1, multiple storage parts 14 accommodating different sizes and types of recording paper P are provided on the lower side of the apparatus body 11. Paper feed rollers 51 having axes extending in the front-rear direction are provided downstream of the storage parts 14 to feed the recording paper P accommodated in the storage parts 14 to the transport path in the transport section 16. Multiple pairs of transport rollers 52 having axes extending in the front-rear direction and rotating in opposite directions are provided downstream of the paper feed rollers 51 to transport the recording paper P one by one.

A pair of registration rollers 54 having axes extending in the front-rear direction are provided downstream of the pair of transport rollers 52 on the extreme downstream side to transport the recording paper P fed from the storage part 14 to the second transfer position T at a predetermined transfer timing. When the pair of transport rollers 52 transport, while nipping therebetween, recording paper P to the pair of registration rollers 54 that are not rotated, the recording paper P forms a so-called loop on the upstream side of the registration rollers 54, and thus, skew is corrected. The skew-corrected recording paper P is sent to the second transfer position T, where the transfer belt 40 and the second transfer roller 44 are in contact with each other, by the pair of registration rollers 54 rotating in opposite directions at a transfer timing.

Pairs of transport rollers 56 and a pair of transport rollers 58 having axes extending in the front-rear direction are provided to the left of the discharge rollers 48 to transport the recording paper P to the registration rollers 54 again in the case of duplex printing, in which an image is formed also on the back surface of the recording paper P. There are multiple pairs of transport rollers 56 and a single pair of transport rollers 58 in a direction of transporting of the recording paper P by the pairs of transport rollers 56.

The recording paper P transported along a reversing path by the pairs of transport rollers 56 is reversed and is then transported by the pair of transport rollers 58, which is located on the extreme downstream side, toward the pair of registration rollers 54 that are not rotated. When the pair of transport rollers 58 transport, while nipping therebetween, the recording paper P, the recording paper P forms a so-called loop on the upstream side of the registration rollers 54 that are not rotated, and thus, skew of the recording paper P is corrected.

### Transport Device

The transport device 60 in the transport section 16 of the thus-configured image forming apparatus 10 will be described in more detail.

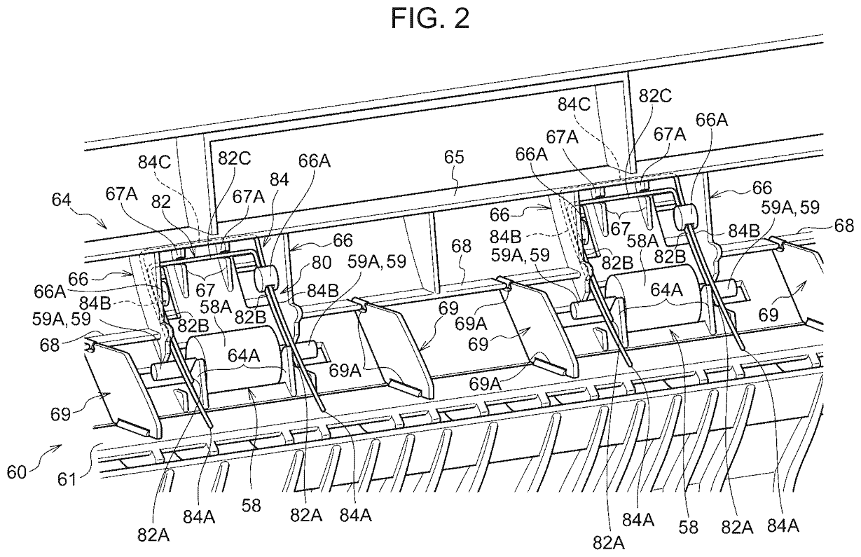

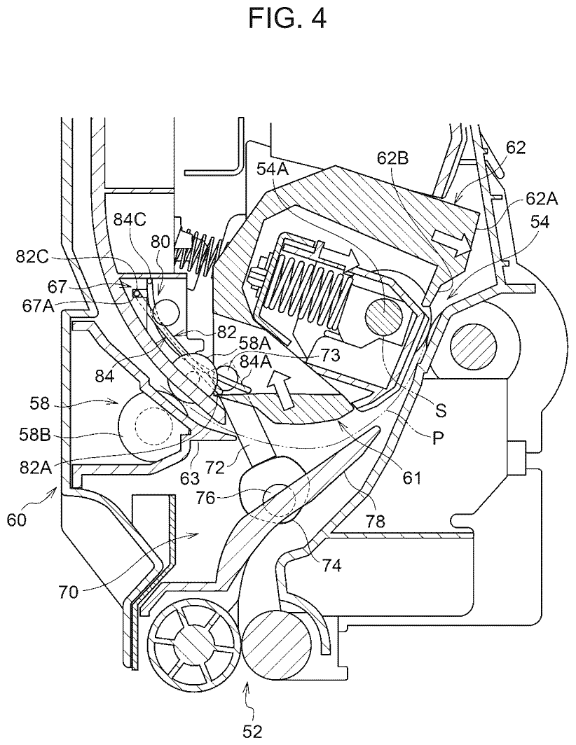

As shown in FIGS. 2 to 4, the transport device 60 includes: the pair of registration rollers 54 (see FIGS. 3 and 4); the pair of transport rollers 58; a first guide part 61 provided downstream of the pair of transport rollers 58 and guiding the recording paper P to the pair of registration rollers 54; a second guide part 62 provided downstream of the pair of registration rollers 54 and guiding the recording paper P to the second transfer position T (transfer part); a position changing mechanism 70 (see FIGS. 3 and 4) that changes the positions of the first guide part 61 and the second guide part 62 according to the type (grammage) of the recording paper P; and a pressure changing mechanism 80 that changes the contact pressure between the pair of transport rollers 58 in conjunction with the first guide portion 61 that has been moved by the position changing mechanism 70.

As shown in FIG. 2, the pair of transport rollers 58 include multiple pairs of transport rollers 58 arranged at predetermined intervals in the front-rear direction. In each pair of transport rollers 58, one (upper) transport roller 58A has a shaft 59 protruding axially outward and having ends 59A that are rotatably supported by support members 64A provided on an upper guide member 64 constituting the transport path of the recording paper P. The other (lower) transport roller 58B (see FIGS. 3 and 4) is rotatably supported by support members (not shown) provided on a lower guide member 63 (see FIGS. 3 and 4) constituting the transport path of the recording paper P.

In each pair of transport rollers 58, one transport roller 58A is urged against the other transport roller 58B so that a contact pressure is generated therebetween. Specifically, the contact pressure between the pair of transport rollers 58 is generated by the urging forces of two spring members 82 and 84, which constitute the pressure changing mechanism 80.

The two spring members 82 and 84 are substantially U-shaped members with the lower ends open and having different sizes in plan view, and are disposed on the inner side and the outer side, respectively. Specifically, the spring members 82 and 84 are configured to press the axially outwardly protruding ends 59A of the one transport roller 58A toward the other transport roller 58B from above and are disposed on the axially inner and outer sides of the ends 59A of the shaft 59, respectively.

The upper guide member 64 is provided with a plate-like beam member 65 extending in the front-rear direction and normal to the vertical direction. The lower surface of the beam member 65 is provided with a pair of plate-like support ribs 66 protruding downward and normal to the front-rear direction. The support ribs 66 are positioned above the ends 59A of the shaft 59 of the one transport roller 58A, and cylindrical retaining projections 66A are integrally formed at substantially the central portions, in the vertical direction, of opposing inner surfaces of the support ribs 66. A pair of plate-like retaining ribs 67 protruding downward and normal to the front-rear direction are provided on the lower surface of the beam member 65, at positions between the pair of support ribs 66.

In the spring member 82, which is on the inner side, lower ends 82A are in contact with the ends 59A of the shaft 59 of the one transport roller 58A from above, intermediate portions 82B are in contact with the retaining projections 66A from below, and a connecting portion 82C at the upper end is retained by the pair of retaining ribs 67, so that the spring member 82 presses (urges) the ends 59A of the shaft 59 toward the other transport roller 58B from above. The pair of retaining ribs 67 have cutout portions 67A that receive the connecting portion 82C of the spring member 82, so that the connecting portion 82C does not come off from the retaining ribs 67.

In the spring member 84, which is on the outer side, lower ends 84A are in contact with the ends 59A of the shaft 59 of the one transport roller 58A from above, intermediate portions 84B are in contact with the retaining projections 66A from below, and a connecting portion 84C at the upper end is retained by upper ends of the retaining ribs 67, which are above the cutout portions 67A, so that the spring member 84 presses (urges) the ends 59A of the shaft 59 toward the other transport roller 58B from above. The lower ends 84A of the outer spring member 84 extend downward beyond the lower ends 82A of the spring member 82 and are in contact with the upper surface of the first guide part 61.

As shown in FIGS. 3 and 4, the first guide part 61 and the second guide part 62 move together to change their positions. Specifically, as shown in FIGS. 3 and 4, the first guide part 61 and the second guide part 62 are connected to each other to form a substantially C shape in cross-section, and the lower end, including the lower distal end, is the first guide part 61, and the upper distal end is the second guide part 62. The first guide part 61 and the second guide part 62 rotate about a virtual rotation axis S, serving as an example of a rotation axis, that is substantially coaxial with a rotation axis 54A of one (left) of the pair of registration rollers 54 to change their positions.

Specifically, a downwardly bulging lower surface of the first guide part 61 constitutes a part of the transport path, and the recording paper P is guided to the pair of registration rollers 54 by the lower surface of the first guide part 61 and the upper surface of a lower guide part 78 (described below). The second guide part 62 has an end 62A facing the transport path of the recording paper P, and an extending portion 62B formed integrally therewith on the lower surface side thereof and extending toward the pair of registration rollers 54. The end 62A and the extending portion 62 form a continuous surface that guides the recording paper P (normal paper) to the second transfer position T.

Rod-shaped link members 72 that are movable in the substantially vertical direction are connected at their upper ends to the left-side upper parts of the first guide part 61 in side view, at both ends of the first guide part 61 in a direction perpendicular to the plane of the drawing of FIG. 3 in side view of the first guide part 61, so as to be rotatable about an axis extending in the front-rear direction. Specifically, the link members 72 are provided with circular through holes at their upper ends, and columnar pins 73 provided at the left-side upper parts of the first guide part 61 in side view, at both ends thereof in the front-rear direction, are fitted to the through holes. With this structure, the link members 72 rotate about the pins 73.

The lower ends of the link members 72 are constantly in contact with the peripheral surfaces of plate-like cam members 74 by at least its own weight or by being urged downward. The cam members 74 are fixed to the axial ends of a shaft 76 extending in the front-rear direction to rotate with the rotation of the shaft 76.

The link members 72 and the cam members 74 provided on the shaft 76 are an example of the position changing mechanism 70. The cam members 74 are disposed outside, in the front-rear direction, the contact region, with respect to the recording paper P, of the lower guide part 78, which guides the recording paper P to the pair of registration rollers 54 together with the first guide part 61. The shaft 76 is supported by the ends, in the front-rear direction, of the non-contact region, with respect to the recording paper P, of the lower guide part 78.

As shown in FIG. 3, when a portion where distance between the outer circumferential surface of the shaft 76 and the outer peripheral surface of the cam member 74 is smallest is located on the upper side, the link members 72 are lowered, bringing the first guide part 61 to a lowered position and the second guide part 62 to a retracted position, at which the second guide part 62 is retracted from the transport path. At this time, the urging forces (pressing forces) of the two spring members 82 and 84 are applied to the ends 59A (see FIG. 2) of the shaft 59 of the one transport roller 58A. Thus, the contact pressure between the pair of transport rollers 58 is maximized.

As shown in FIG. 4, when a portion where the distance between the outer circumferential surface of the shaft 76 and the outer peripheral surface of the cam member 74 is largest is located on the upper side, the link members 72 are moved upward, bringing the first guide part 61 to a raised position and the second guide part 62 to a projecting position, at which the second guide part 62 projects into the transport path. At this time, only the lower ends 84A of the spring member 84, which is on the outer side, are separated from the ends 59A of the shaft 59 of the one transport roller 58A.

Specifically, at this time, the ends 59A (see FIG. 2) of the shaft 59 of the one transport roller 58A are subjected to only the urging force (pressing force) of the spring member 82, and thus, the pressing force applied to the ends 59A of the shaft 59 of the one transport roller 58A, i.e., the contact pressure between the pair of transport rollers 58, is reduced.

In this way, the vertical movement of the first guide part 61 switches between the use of one and both of the spring members 82 and 84, and thus changes the contact pressure between the pair of transport rollers 58. When the contact pressure between the pair of transport rollers 58 is changed, the pair of transport rollers 58 are maintained in contact with each other by at least the urging force of the spring member 82, which is not separated from the ends 59A of the shaft 59 of the one transport roller 58A.

As shown in FIG. 2, plate-like connecting members 68 extending in the front-rear direction and normal to the vertical direction connect the lower ends of the outer surfaces of pairs of support ribs 66 adjacent to each other in the front-rear direction. Substantially rectangular plate-like reinforcing members 69 are provided between the lower surfaces of the connecting members 68 and the upper surface of the first guide part 61 via hinges 69A having pivoting axes extending in the left-right direction. Thus, the first guide part 61 is configured to move upward while moving rearward.

The operation of the thus-configured transport device 60 according to the first exemplary embodiment will be described below.

Typically, when the recording paper P is thick paper, a high contact pressure between the pair of transport rollers 58 and a small space between the lower surface of the first guide part 61 and the upper surface of the lower guide part 78 are better. Specifically, while thick paper is transported by the pair of transport rollers 58, the leading end of the thick paper is abutted against the pair of registration rollers 54 that are not rotated to form a loop for correcting skew between the pair of transport rollers 58 and the pair of registration rollers 54. In the case of thick paper, it is better that the space for forming the loop is small.

Furthermore, when the recording paper P is thick paper, it is better that the width of the transport path on the downstream side of the pair of registration rollers 54 is large. If the width of the transport path on the downstream side of the pair of registration rollers 54 is small, the thick paper may contact the continuous surface of the end 62A and the extending portion 62B of the second guide part 62 and may be forcibly bent to be transported, which may cause transport resistance, registration error, image shrinkage, or damage.

Hence, when the recording paper P is thick paper, as shown in FIG. 3, the first guide part 61 is set to the lowered position, and the second guide part 62 is set to the retracted position. By transporting thick recording paper P in this state, the parallelism of the thick paper is ensured, the occurrence of wrinkles in the thick paper may be suppressed or prevented, and the thick paper may not be forcibly bent to be transported, and thus, transport resistance and the like may not occur, compared with the case where the contact pressure between the pair of transport rollers 58 with respect to the recording paper P and the width of the transport path on the downstream side of the pair of registration rollers 54 are constant regardless of the type (grammage) of the recording paper P. Accordingly, a transport error of the thick paper to the pair of registration rollers 54 and the second transfer position T may be suppressed or prevented, and the occurrence of an image quality defect due to the transport error may be suppressed or prevented.

Meanwhile, when the recording paper P is normal paper, which is thinner than thick paper, the contact pressure between the pair of transport rollers 58 does not need to be high, and it is better that the space between the lower surface of the first guide part 61 and the upper surface of the lower guide part 78 is large. Specifically, while normal paper is transported by the pair of transport rollers 58, the leading end of the normal paper is abutted against the pair of registration rollers 54 that are not rotated to form a loop for correcting skew between the pair of transport rollers 58 and the pair of registration rollers 54. In the case of normal paper, it is better that the space for forming the loop is large.

This is because, when the leading end of the normal paper is abutted against the pair of registration rollers 54 that are not rotated, the normal paper may take on an upwardly bulging shape by twisting or the like, and, if the space for forming the loop described above is small, the normal paper may be relatively pushed downward by the lower surface of the first guide part 61, and may be vertically sandwiched between the lower surface of the first guide part 61 and the upper surface of the lower guide part 78, which may generate further excessive twisting in the normal paper.

Furthermore, when the recording paper P is normal paper, it is better that the width of the transport path on the downstream side of the pair of registration rollers 54 is small. This is because, if the width of the transport path on the downstream side of the pair of registration rollers 54 is large, the continuous surface of the end 62A and the extending portion 62B of the second guide part 62 is unlikely to contact the normal paper, making the orientation of the normal paper unstable and potentially producing wrinkles in the normal paper. In other words, the normal paper needs to be positively brought into contact with the second guide part 62 until the normal paper reaches the second transfer position T, so that the orientation of the normal paper is regulated.

Hence, when the recording paper P is normal paper, as shown in FIG. 4, the first guide part 61 is set to the raised position, and the second guide part 62 is set to the extended position. Then, the lower ends 84A of the spring member 84 are separated from the ends 59A of the shaft 59 of the one transport roller 58A. In this way, when the normal paper passes through the transport path, the loop forming space is enlarged, the contact pressure between the pair of transport rollers 58 is reduced, and the width of the transport path on the downstream side of the pair of registration rollers 54 is reduced.

By transporting normal recording paper P in this state, a transport error of the normal paper to the pair of registration rollers 54 and the second transfer position T may be suppressed or prevented, compared with the case where the contact pressure of the pair of transport rollers 58 with respect to the recording paper P and the width of the transport path on the downstream side of the pair of registration rollers 54 are constant regardless of the type (grammage) of the recording paper P, that is, the case where the positions of the first guide part 61 and the second guide part 62 and the contact pressure between the pair of transport rollers 58 are the same as those in the case of thick paper.

Specifically, even when the normal paper takes on an upwardly bulging shape due to twisting or the like, the normal paper is not relatively pressed downward by the lower surface of the first guide part 61 because of the large loop forming space. The firmness of the normal paper produced by being transported by the transport rollers 58 eliminates twisting or the like and ensures the parallelism of the normal paper, and thus, the occurrence of wrinkles in the normal paper may be suppressed or prevented. The normal paper is positively brought into contact with the continuous surface of the end 62A and the extending portion 62B of the second guide part 62 and is transported to the second transfer position T while the orientation thereof is regulated. Thus, the occurrence of an image quality defect due to the transport error may be suppressed or prevented.

In addition, when the recording paper P is normal paper, the contact pressure between the pair of transport rollers 58 is reduced (or is prevented from reaching an excessive contact pressure), so, wear of the transport rollers 58 may be suppressed, and the power consumption of a motor (not shown) that drives the transport rollers 58 may be reduced.

In addition, because the loop forming space is enlarged only when the recording paper P is thinner than thick paper (for example, normal paper), the size of the apparatus body 11 of the image forming apparatus 10 may be designed in accordance with the loop forming space for thick paper. Thus, the size of the image forming apparatus 10 (apparatus body 11) may be reduced.

The first guide part 61 and the second guide part 62 move together to change their positions. In other words, the first guide part 61 and the second guide part 62 are formed integrally. Thus, the component count may be reduced to simplify the structure of the position changing mechanism 70, compared with the case where the first guide part 61 and the second guide part 62 are configured to move separately to change their positions.

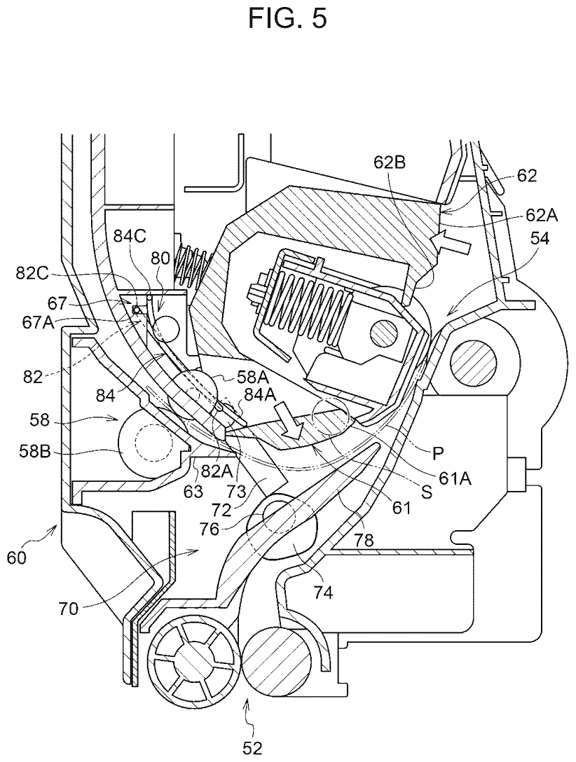

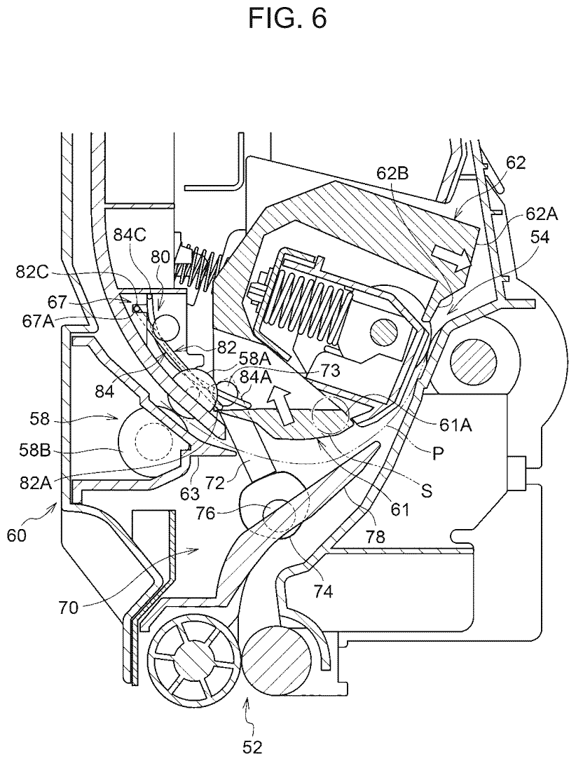

The first guide part 61 and the second guide part 62 rotate about a virtual rotation axis S that is substantially coaxial with the rotation axis 54A of the pair of registration rollers 54 to change their positions. Hence, the positions of the first guide part 61 and the second guide part 62 may be accurately changed, compared with the case where the first guide part 61 and the second guide part 62 rotate about, for example, a downstream end 61A (see FIGS. 5 and 6) of the first guide part 61 to change their positions.

The second guide part 62 has the extending portion 62B extending toward the pair of registration rollers 54 at the end 62A facing the transport path of the recording paper P. This may prevent the recording paper P (normal paper) from entering the space between the pair of registration rollers 54 and the lower surface of the second guide part 62, compared with the case where the second guide part 62 has, for example, an extending portion (not shown) extending toward the side opposite to the pair of registration rollers 54 at the end 62A facing the transport path of the recording paper P. Thus, a transport error of the recording paper P transported by the pair of registration rollers 54 may be suppressed or prevented.

Furthermore, because the pressure changing mechanism 80 is formed of the two spring members 82 and 84, the structure of the pressure changing mechanism may be simple, compared with the case where the pressure changing mechanism is formed of, for example, an electric actuator (not shown) or the like that directly presses the ends 59A of the shaft 59 to change the pressure. Moreover, because the spring members 82 and 84 are thin wires simply bent in a substantially U shape, they may be inexpensive and may contribute to reduction in manufacturing cost.

The spring members 82 and 84 are formed in a substantially U shape and press the ends 59A of the shaft 59 of the one transport roller 58A toward the other transport roller 58B. Hence, the spring members 82 and 84 may be easily assembled with respect to the first guide part 61, compared with the case where the ends 59A of the shaft 59 of the one transport roller 58A are pressed toward the other transport roller 58B by individual springs (coil springs, torsion springs, or the like).

In a structure in which one transport roller 58A is separated from the other transport roller 58B, a transport force of the recording paper P to the registration rollers 54 that are not rotated decreases, and thus, the skew correction capability decreases. In contrast, the pair of transport rollers 58 according to this exemplary embodiment are maintained in contact with each other, so, decrease in the skew correction capability may be suppressed or prevented, compared with the structure in which one transport roller 58A is separated from the other transport roller 58B.

### Second Exemplary Embodiment

Next, a second exemplary embodiment will be described. The same reference signs denote the same parts as those in the first exemplary embodiment, and detailed description (including common operation) will be omitted where appropriate.

As shown in FIGS. 5 and 6, the second exemplary embodiment differs from the first exemplary embodiment only in that the first guide part 61 and the second guide part 62 rotate about the vicinity of the downstream end (lower end) 61A of the first guide part 61 to change their positions. Specifically, the vicinity of the downstream end 61A of the first guide part 61 is set as a virtual rotation axis S, and the first guide part 61 and the second guide part 62 rotate about the virtual rotation axis S to change their positions.

This configuration may enable the position of the second guide part 62 to be easily changed, compared with the case where the first guide part 61 and the second guide part 62 rotate about, for example, the virtual rotation axis that is substantially coaxial with the rotation axis 54A (see FIGS. 3 and 4) of one (left side) of the pair of registration rollers 54 to change their positions. In other words, this may enable the second guide part 62 to be moved to the retracted position with a small force.

Although the transport device 60 according to this exemplary embodiment has been described above with reference to the drawings, the transport device 60 according to this exemplary embodiment is not limited to the one shown in the drawings, and the design thereof may be appropriately changed within the scope not departing from the gist of the present disclosure. For example, recording paper P thinner than thick paper may be thin paper thinner than normal paper. Furthermore, as long as the first guide part 61 and the second guide part 62 move together to change their positions, the first guide part 61 and the second guide part 62 do not necessarily have to be formed integrally.

Furthermore, the spring member 84, which is separated from the ends 59A of the shaft 59 of the one transport roller 58A by the first guide part 61, may be disposed on the inner side of the spring member 82, which is not separated from the ends 59A of the shaft 59 of the one transport roller 58A. The first guide part 61 may move upward while moving forward.

The pressure changing mechanism 80 that changes the contact pressure between the pair of transport rollers 58 in conjunction with the first guide part 61 that has been moved by the position changing mechanism 70 is not necessarily have to be formed of the two spring members 82 and 84 formed in a substantially U shape, but may be made of spring members of another shape, an actuator (not shown), or the like as long as the contact pressure between the pair of transport rollers 58 is adjustable as described above.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))
   A transport device comprising:
      a pair of registration rollers that transport a recording medium to a transfer part at a predetermined timing;
      a pair of transport rollers that are provided upstream of the pair of registration rollers in a recording-medium transport direction and transport the recording medium toward the pair of registration rollers that are not rotated;
      a first guide part that is provided downstream of the pair of transport rollers in the recording-medium transport direction and guides the recording medium to the pair of registration rollers;
      a second guide part that is provided downstream of the pair of registration rollers in the recording-medium transport direction and guides the recording medium to the transfer part;
      a position changing mechanism that changes positions of the first guide part and the second guide part according to a type of the recording medium; and
      a pressure changing mechanism that changes a contact pressure between the pair of transport rollers in conjunction with the first guide part that has been moved by the position changing mechanism.
(((2)))
   The transport device according to (((1))), wherein the position changing mechanism changes the positions of the first guide part and the second guide part in accordance with a grammage of the recording medium.
(((3)))
   The transport device according to (((1))) or (((2))), wherein, when the recording medium is paper thinner than thick paper,
   the position changing mechanism changes the position of the first guide part so that a space on a downstream side of the pair of transport rollers in the recording-medium transport direction is larger than that in the case of thick paper, and changes the position of the second guide part so that a width of a transport path on a downstream side of the pair of registration rollers in the recording-medium transport direction is smaller than that in the case of thick paper, and
   the pressure changing mechanism changes the contact pressure between the pair of transport rollers so that the contact pressure is lower than that in the case of thick paper.
(((4)))
   The transport device according to any one of (((1))) to (((3))), wherein the first guide part and the second guide part are configured to move together to change positions thereof.
(((5)))
   The transport device according to (((4))), wherein the first guide part and the second guide part rotate about a rotation axis that is coaxial with a rotation axis of the pair of registration rollers to change positions thereof.
(((6)))
   The transport device according to (((4))), wherein the first guide part and the second guide part rotate about a downstream end of the first guide part in the recording-medium transport direction to change positions thereof.
(((7)))
   The transport device according to any one of (((1))) to (((6))), wherein the second guide part has an extending portion extending toward the pair of registration rollers at an end thereof facing a transport path of the recording medium.
(((8)))
   The transport device according to any one of (((1))) to (((7))), wherein the pressure changing mechanism includes two spring members having different urging forces, and the contact pressure between the pair of transport rollers is changed by using one or both of the two spring members.
(((9)))
   The transport device according to (((8))), wherein the two spring members have a U shape and are configured to press axially outwardly protruding ends of a shaft of one transport roller of the pair of transport rollers toward the other transport roller.
(((10)))
   An image forming apparatus including:
      the transport device according to any one of (((1))) to (((9)));
      a transfer part that transfers a toner image to a recording medium transported by the transport device; and
      a fixing device that fixes the toner image transferred by the transfer part to the recording medium.

What is claimed is:

1. A transport device comprising:
a pair of registration rollers that transport a recording medium to a transfer part at a predetermined timing;
a pair of transport rollers that are provided upstream of the pair of registration rollers in a recording-medium transport direction and transport the recording medium toward the pair of registration rollers that are not rotated;
a first guide part that is provided downstream of the pair of transport rollers in the recording-medium transport direction and guides the recording medium to the pair of registration rollers;
a second guide part that is provided downstream of the pair of registration rollers in the recording-medium transport direction and guides the recording medium to the transfer part;
a position changing mechanism that changes positions of the first guide part and the second guide part according to a type of the recording medium; and
a pressure changing mechanism that changes a contact pressure between the pair of transport rollers in conjunction with the first guide part that has been moved by the position changing mechanism.

2. The transport device according to claim 1, wherein the position changing mechanism changes the positions of the first guide part and the second guide part in accordance with a grammage of the recording medium.

3. The transport device according to claim 1, wherein, when the recording medium is paper thinner than thick paper,
the position changing mechanism changes the position of the first guide part so that a space on a downstream side of the pair of transport rollers in the recording-medium transport direction is larger than that in the case of thick paper, and changes the position of the second guide part so that a width of a transport path on a downstream side of the pair of registration rollers in the recording-medium transport direction is smaller than that in the case of thick paper, and
the pressure changing mechanism changes the contact pressure between the pair of transport rollers so that the contact pressure is lower than that in the case of thick paper.

4. The transport device according to claim 1, wherein the first guide part and the second guide part are configured to move together to change positions thereof.

5. The transport device according to claim 4, wherein the first guide part and the second guide part rotate about a rotation axis that is coaxial with a rotation axis of the pair of registration rollers to change positions thereof.

6. The transport device according to claim 4, wherein the first guide part and the second guide part rotate about a downstream end of the first guide part in the recording-medium transport direction to change positions thereof.

7. The transport device according to claim 1, wherein the second guide part has an extending portion extending toward the pair of registration rollers at an end thereof facing a transport path of the recording medium.

8. The transport device according to claim 1, wherein the pressure changing mechanism includes two spring members having different urging forces, and the contact pressure between the pair of transport rollers is changed by using one or both of the two spring members.

9. The transport device according to claim 8, wherein the two spring members have a U shape and are configured to press axially outwardly protruding ends of a shaft of one transport roller of the pair of transport rollers toward the other transport roller.

10. An image forming apparatus including:
the transport device according to claim 1;
a transfer part that transfers a toner image to a recording medium transported by the transport device; and
a fixing device that fixes the toner image transferred by the transfer part to the recording medium.

11. An image forming apparatus including:
the transport device according to claim 2;
a transfer part that transfers a toner image to a recording medium transported by the transport device; and
a fixing device that fixes the toner image transferred by the transfer part to the recording medium.

12. An image forming apparatus including:
the transport device according to claim 3;
a transfer part that transfers a toner image to a recording medium transported by the transport device; and
a fixing device that fixes the toner image transferred by the transfer part to the recording medium.

13. An image forming apparatus including:
the transport device according to claim 4;
a transfer part that transfers a toner image to a recording medium transported by the transport device; and
a fixing device that fixes the toner image transferred by the transfer part to the recording medium.

14. An image forming apparatus including:
the transport device according to claim 5;
a transfer part that transfers a toner image to a recording medium transported by the transport device; and
a fixing device that fixes the toner image transferred by the transfer part to the recording medium.

15. An image forming apparatus including:
the transport device according to claim 6;
a transfer part that transfers a toner image to a recording medium transported by the transport device; and
a fixing device that fixes the toner image transferred by the transfer part to the recording medium.

16. An image forming apparatus including:
the transport device according to claim 7;
a transfer part that transfers a toner image to a recording medium transported by the transport device; and
a fixing device that fixes the toner image transferred by the transfer part to the recording medium.

17. An image forming apparatus including:
the transport device according to claim 8;
a transfer part that transfers a toner image to a recording medium transported by the transport device; and
a fixing device that fixes the toner image transferred by the transfer part to the recording medium.

18. An image forming apparatus including:
the transport device according to claim 9;
a transfer part that transfers a toner image to a recording medium transported by the transport device; and
a fixing device that fixes the toner image transferred by the transfer part to the recording medium.
